(19) United States
(12) Patent Application Publication
(10) Pub. No.: US 2025/0282562 A1
(43) Pub. Date: Sep. 11, 2025

(54) GRIPPING DEVICE, HANDLING SYSTEM AND METHOD FOR HANDLING PIECE GOODS

(71) Applicant: Korber Supply Chain Logistics GmbH, Konstanz (DE)

(72) Inventors: Marco Fischer, Konstanz (DE); Rolf-Peter Skrdlant, Überlingen (DE); Richard Huber, Konstanz (DE); Dirk-Udo Eisser, Reichenau (DE); Oliver Schulze, Überlingen (DE)

(21) Appl. No.: 19/072,003

(22) Filed: Mar. 6, 2025

(30) Foreign Application Priority Data
Mar. 6, 2024 (DE) 10 2024 106 475.7

(51) Int. Cl. B65G 47/90; B65G 47/91

(52) U.S. Cl. CPC B65G 47/905; B65G 47/91

(57) ABSTRACT

A gripping device for handling piece goods, in particular for use in a sorting process includes a gripping element configured to handle a piece good, an actuator configured to move and align the gripping element, at least one sensor configured to determine the force acting on the gripping element by the piece good and to output it as force information, and a control unit configured to control the actuator in such a way that the piece good is aligned and/or moved in space based on the force information.

### BACKGROUND

The present disclosure relates to a gripping device for handling piece goods, in particular for use in a sorting process, a handling system for handling piece goods and a method for handling piece goods.

Automated handling devices are used to automate handling processes in parcel logistics. Such handling devices, such as gripping devices, which are often realized as robots, can physically move piece goods such as parcels, packages, shipping bags, smalls, transport rolls, envelopes and the like. The handling devices can be used, for example, in sorting processes, order picking processes or the like. Since the properties of the piece goods (such as weight, center of gravity, surface characteristics and the like) are often unknown, it is difficult to operate the handling devices in an optimal range or operating point. More specifically, piece goods are often handled with too much force to ensure that the piece good does not fall off.

It is therefore an object of the present disclosure to provide a gripping device and a method for handling piece goods, in each of which it is possible to handle a piece good efficiently.

### SUMMARY

According to one aspect of the present disclosure, a gripping device for handling piece goods, in particular for use in a sorting process, is provided. The gripping device may comprise a gripping element designed to handle a piece good. Furthermore, the gripping device can comprise an actuator that is designed to move and/or align the gripping element. Furthermore, the gripping device can comprise at least one sensor which is designed to determine the force exerted on the gripping element by the piece goods and to output it as force information. Furthermore, the gripping device can comprise a control unit which is designed to control the actuator in such a way that the piece goods are aligned and/or moved in space based on the force information.

Compared to the prior art, the object of the present disclosure provides the advantage that a piece good can be held on the gripping device in such a way that efficient operation of the gripping device is ensured. Furthermore, by aligning and/or moving the piece goods based on the force information, the piece good can be handled or treated individually. This avoids oversizing when handling the piece good. Such oversizing can occur, for example, if too high a gripping force (e.g. mechanical gripping force or suction force) is used. Furthermore, by taking force information into account, other properties of the piece good can be taken into account or addressed. For example, a change in the piece good during the handling process can be taken into account. This can reduce wear on the gripping device. More specifically, by taking the force information into account, the piece good can be aligned and/or moved in space in such a way that the load on the gripping device is as low as possible. Furthermore, it is possible to use the gripping device to determine the center of mass (hereinafter simply referred to as the center of gravity) of the piece goods. With this information, the piece good can be held on the gripping device in such a way that the lowest possible (i.e. the minimum) holding force of the gripping device is required to hold the piece good. Furthermore, this can minimize the force acting on the gripping element, which can simplify the handling of the piece good. Furthermore, this can increase the efficiency of the handling process.

The gripping device can be a device designed to physically move piece goods such as items of mail such as parcels, packages, envelopes, smalls, transport rolls and the like. (i.e. to handle). In other words, the gripping device can be designed to move a piece good from one point of origin to another point in space. For this purpose, the gripping device can grasp, hold and/or move the piece good. Optionally, the gripping device can lift the piece good against the direction of gravity. This is advantageous, for example, in sorting processes for piece goods, such as in a mail center. Here, piece goods can be transported to different destinations depending on the piece good information. In other words, a stream of piece goods can be sorted by a gripping device by transporting the individual piece goods depending on piece good information to different positions (depending on the piece good information). The gripping element can be a part of the gripping device that can come into direct contact with the piece goods. The gripping element can be designed to hold the piece goods so that the piece goods can be transported to the desired destination. The gripping element can be designed to remove or pick up the piece goods from a feed area and deposit them in a discharge area. The gripping element can, for example, be a functional end of a robot arm. The actuator can be designed to move and/or align the gripping element. The actuator can comprise a motor, in particular an electric motor, and/or at least one joint. In the event that the gripping element is a functional end of a robot arm, the actuator can move the robot arm so that it can reach any position in 3-dimensional space. Additionally or alternatively, the actuator can be designed to vary a holding position in which the piece or the gripping element is held. For example, the actuator can rotate, tilt, incline, etc. the gripping element so that any orientation in space is possible. In other words, the actuator can move the piece good held by the gripping element in six degrees of freedom (forwards/backwards, up/down, left/right, yaw, pitch and roll). This means that the position and/or orientation of the piece good in space can be freely and individually selected. The sensor can be designed to determine a force resulting from the handling of a piece good during handling. In other words, as soon as the gripping element comes into contact with a piece good, the sensor can determine a force that acts on the gripping element due to the piece good. Optionally, the sensor can be designed to determine the force acting on the gripping element during a movement and/or alignment of the gripping element. Optionally, the sensor can determine the force continuously. Optionally, the sensor can be designed to determine the force acting on the gripping element at predetermined alignments and/or positions of the gripping element. For example, the sensor can determine the force immediately after the first contact between the gripping element and the piece good. The sensor can then determine the force at a specific orientation of the gripping element in space. A large number of positions and/or orientations can be provided, which are approached by the gripping element during handling of the piece good, at each of which a force is determined. Each force determined in this way can be output as force information. In this way, at least one piece of information about the piece good can be obtained. The force information can be output by the sensor to a control unit. The control unit can be a computer-like device that is designed to receive information (input information), process information and output information (output information or control commands). The control unit can receive the force information as input information. Based on the force information, the control unit can output information in the form of control commands to the actuator. For example, the control unit can check which orientation and/or position of the gripping element exerts the least force from the piece good on the gripping element. In this position, the lowest force is also required to hold and/or move the piece good with the gripping element. In other words, this position and/or orientation can be regarded as the most efficient position and/or orientation in which the piece good can be held and/or moved on the gripping element. It is conceivable, for example, that the control unit is designed to control the actuator in such a way that certain changes are made in at least one of the six degrees of freedom after the piece good has been picked up, and the position and/or orientation in which the least force acts on the gripping element can be determined by measuring the force acting on the gripping element. This can ensure that the piece good is optimally aligned relative to the gripping device so that the least force is required to hold and/or move the piece good. Such a process can be comparable to balancing a tray on several fingers. This can result in efficient handling of piece goods. It can also reduce wear on the gripping device. In addition, the gripping element can apply just as much force as is necessary to hold and/or move the piece good. On the one hand, this allows the piece good to be held securely on the gripping element and, on the other hand, avoids wasting energy.

Optionally, the control unit is designed to control the actuator in such a way that the force acting on the gripping element is minimized. In other words, a feedback control can be implemented which, based on the force information, controls the actuator so that the force between the gripping element and the piece good is minimal. In this case, minimum does not necessarily mean the absolute lowest value. Rather, minimal can mean that of all the force information recorded (for example, when measuring the force at certain time intervals), the force that is the lowest compared to all other measured forces is considered minimal. This can easily increase the efficiency of the handling process.

Optionally, the control unit is designed to control the actuator based on the force information so that the piece good is balanced on the gripping element. In this way, for example, a center of gravity of the piece good can be determined and the piece good can also be handled upside down relative to the gripping device. For example, it is conceivable that while the piece good is balanced overhead, the gripping device is exposed to suction of the piece good. By knowing the center of gravity of the piece good, the piece good can be placed on the gripping element in such a way that it does not fall down. Furthermore, acceleration forces acting on the piece good can also be taken into account when balancing the piece good. For example, the gripping element can be tilted during a movement in order to prevent the piece good from falling when the gripping element moves. This can increase the possible uses of the gripping device.

Optionally, the control unit is designed to control the actuator based on the force information in such a way that a center of gravity of the piece good is in line with the gripping element, wherein the line is parallel to the direction of gravity. In other words, in a case where the gripping element does not grip the piece good at the center of mass of the piece goods, an occurring moment can be compensated by aligning the piece good with the gripping element. This makes it possible to place the center of gravity of the piece good and the center of gravity of the gripping element on a vertical line in the direction of gravity. The vertical line can correspond to the direction of gravity. As a result, the force required to hold, move and/or align the piece good can be minimized.

Optionally, the control unit is designed to determine and/or obtain a center of gravity of the piece good based on the force information and to control the actuator based on the center of gravity of the piece good. In other words, a center of gravity of the piece goods can also be determined without the need for an iterative approach (i.e. measurement, correction, measurement, correction, etc.). For this purpose, for example, several sensors can be provided on the gripper element, each of which can transmit force information to the control unit. Depending on the respective force information and the position of the sensors on the gripping element, the control unit can then determine where the center of gravity of the piece good currently being handled is located. Accordingly, it can control the actuator in such a way that a position and/or orientation of the piece good is approached directly at which the force between the piece good and the gripping element is minimal. This can reduce the time it takes to reach the optimum position and/or orientation of the piece good compared to the case where this position is determined iteratively.

Optionally, the control unit is designed to control a handling speed of the actuator based on the force information. The handling speed can be the speed at which the gripping device transports the piece good from the pick-up position to the discharge position. It can be roughly assumed that the greater the handling speed, the greater the force acting between the gripping element and the piece good. In other words, this can mean that if the piece good is handled quickly, a greater holding force is required to hold the piece good compared to slower handling. By minimizing the holding force required to hold the piece good on the gripping element through a movement and/or orientation of the piece good initiated by the control unit, the handling speed can be increased without the risk of the piece good falling off the gripping element. This allows accelerated handling to be realized.

Optionally, the control unit is designed to control the actuator based on an inertial force of the piece good. In other words, in the case of highly dynamic movement sequences of the gripping device, for example, inertial forces acting on the piece good can be taken into account in order to keep the piece good in the optimum position and/or alignment. This allows the piece good to be kept in balance. Depending on the target position to which the piece good is to be transported by the gripping device, the control unit can therefore take acceleration values into account in order to determine the optimum position and/or alignment of the piece good on the gripping element. For example, the piece good can be oriented before and/or during a movement of the piece good so that the force acting on the gripping element is minimized. This means that the piece good can be handled even more efficiently.

Optionally, the control unit can be designed to determine an angle of inclination and/or a grip strength of the gripping element based on the force information. The angle of inclination can be an angle of a plane in which contact is made between the piece good and the gripping element. In other words, the gripping element can define a plane that represents the boundary between the gripping element and the piece good. This gripping level can be tilted (i.e. inclined) until the actual center of gravity of the piece good is centered below the gripping element and the forces are equalized. This allows the number of degrees of freedom to be reduced, making it easier to control the gripping device. In particular, only the inclination can be varied. The gripping force of the gripping element can be (for example a vacuum suction cup) or a force (for mechanical grippers). Depending on the piece good, a different gripping strength is required to handle the piece good. For example, a piece good can be gripped with an initial gripping force until the control unit receives the first force information. Based on this, it can be evaluated whether the grip strength implemented is sufficient to handle the piece good safely and efficiently. If it is determined that the grip strength is oversized, it can be reduced to improve the efficiency of the overall process. Conversely, if it is determined that the grip strength is not sufficient to ensure safe handling of the piece good, the grip strength can be increased. This allows the handling process to be implemented reliably.

Optionally, the control unit is designed to determine a mass of a piece good based on the force information. In other words, the control unit can be supplied with the orientation and/or alignment of the gripping element and the force information, whereupon the control unit can determine a mass of the piece good. Furthermore, such a determination can be made during the movement of the piece good itself, in that the acceleration values are also made available to the control unit so that it can calculate the resulting inertial forces when determining the mass. This allows further piece good information to be created and/or checked while the gripping device is handling the piece goods. Furthermore, the piece good can have a non-cubic shape instead of an inhomogeneous mass distribution. This can result in the center of mass not being below a gripper surface. In other words, the orientation of the piece good can be based on the center of mass and not just on a geometric center of mass. This means that a wider range of piece goods can be handled.

Optionally, the control unit can be designed to control the actuator based on the force information in such a way that a lever arm acting on the gripping device is minimized. This can minimize wear on the gripping device. The energy consumption required to handle the piece good can also be minimized.

Optionally, the control unit is designed to control the actuator in such a way that, by iterative displacement and/or reorientation of the piece good, the position is determined at which a force acting on the gripping element by the piece goods is minimal. In other words, the control unit can be designed to determine when a force on the gripping element is minimal by continuously or selectively recording and evaluating force information during handling of the piece good. An iterative control system can thus be provided to determine an orientation of the piece good at which an acting force is minimal.

Optionally, the at least one sensor is provided directly on the gripping element. In other words, the measurement can be carried out directly on the gripping element. This makes it possible to determine with local resolution where on the gripping element which force is acting. For example, a gripping element can have a large number of grippers. In this case, a sensor can be provided on each gripper. This allows force information to be assigned to each gripper and evaluated accordingly by the control unit. Furthermore, local differences on the surface of piece goods can also be detected in this way. If several grippers are provided on the gripping element, it is possible, for example, to detect if a lower force is applied at one point than at the other (e.g. when using a vacuum gripper). This allows conclusions to be drawn about different surfaces of the piece good.

Optionally, the control unit is designed to determine an optimum gripping point of a piece of good so that the force acting on the gripping element is minimized when handling the piece of good with the gripping device. The gripping point can be a point on the surface of the piece good that can be contacted by the gripping element. For example, if the gripping device has gripped a piece of good and aligned and/or moved it in such a way that a force on the gripping element is minimal, the control unit can define a gripping position on the piece of good to be gripped in order to reach the optimum position more quickly. In other words, the optimum gripping point for a piece good can be determined even if the piece good is not currently gripped by the gripping element at this gripping point. The gripping point can be used to control the actuator to move the gripping element in such a way that the least force is applied between the gripping element and the piece good. The gripping point can be at different points for different piece goods.

Optionally, the control unit can be designed to store the optimum gripping point in a storage unit. More precisely, the control unit can store the optimum gripping point together with other piece good information. The optimum gripping point can, for example, be identical or at least similar for a class of piece goods. Therefore, the optimum gripping point can be defined for a class of piece goods and stored if necessary. This means that the gripping point can be determined directly before the piece good is gripped if a new piece good has already been handled. This can ensure that the piece good is gripped at the optimum position (i.e. at the optimum gripping point) when the piece good of the same class occurs again. As a result, a learning effect can be implemented in the control of the gripping device, so that when similar piece goods are repeatedly picked up, the gripping device grips them at the point that allows highly efficient handling of the piece good.

Optionally, the control unit is designed to load the optimum gripping point from the storage unit. The storage unit can be a database to which the control unit can have access. During operation, the control unit can record the piece good information (e.g. an image of a piece good) and compare it with the piece good information stored in the database. If a hit occurs (for example with a predetermined deviation spectrum), the corresponding gripping point can be loaded and the actuator can be controlled so that the respective gripping point of the piece good is approached directly. This can increase the efficiency of the system. This means that more sensible gripping points away from the geometric center of gravity can be determined in advance during subsequent gripping tests. This means that piece goods with an eccentric center of gravity can also be handled without any problems.

Optionally, the control unit is designed to additionally control the actuator based on an image of the piece good. An image of the piece good can be used to determine a first gripping point based on the dimensions of the piece goods. It can be assumed, for example, that the piece good consists of a homogeneous material and that the geometric center of gravity is therefore also the center of mass. The gripping point for a piece good can be corrected after the piece good has been handled and stored in the storage unit. This means that if the same piece good reappears, the more suitable gripping point can be approached directly. For this purpose, the piece goods can be classified into different classes and stored accordingly in the storage unit. The gripping point can also be stored in a database as additional piece good information. Furthermore, the image can be used to identify whether a piece good has already been handled in the past and any information about the piece good is therefore available. More specifically, the image of the piece good can be used to check whether an optimum gripping position is already available for the piece good. This means that handling can be improved and accelerated if piece goods of the same piece good class occur.

Optionally, the sensor comprises a piezo-electric sensor, a distance sensor, a pressure sensor, an optical sensor, a load switch and/or a volume flow sensor. The piezo-electric sensor can utilize the piezo-electric effect and generate a voltage when a force is applied, which in turn is measured. The distance sensor can be a measuring device for determining the distance between the gripping element and the piece good. The distance sensor can use three different methods: The time it takes for a signal to return, the intensity of the returning signal and/or the phase change of the returning signal. The sensors that can be used are ultrasonic sensors, infrared distance sensors, LED time-of-flight distance sensors and phase shift sensors. The pressure sensor can determine an electrical output variable as a measure of pressure. For example, a piezo-resistive or strain gauge pressure sensor, a piezoelectric pressure sensor, a frequency-analog pressure sensor, a pressure sensor with a Hall element, a capacitive pressure sensor, an inductive pressure sensor and the like can be used as a pressure sensor.

An optical sensor can be implemented to detect a difference between light and dark. This makes it possible to determine whether a piece good is positioned on the gripping element or not. A load switch can be arranged to determine whether a force is applied to the gripping element in a certain area or not. The load switch can be combined with a piezo-electric element, for example. A volume flow sensor can be designed to measure a volume flow to a gripper of the gripping element, wherein the gripper is designed as a suction gripper. This makes it possible to determine whether a piece good is held satisfactorily on the gripping element (no leakage flow) or whether the piece good is not held well on the gripping element (occurrence of a leakage flow). All of these sensors can be designed to determine or at least estimate a force that prevails between the gripping element and the piece good and/or to determine whether or not a piece good is positioned on the gripping element.

Optionally, the gripping device also comprises a control sensor for monitoring the function of the at least one sensor. The control sensor can, for example, be provided at a different position to the at least one sensor on the gripping device. For example, the control sensor can measure a motor current of the actuator. This makes it possible to determine whether the force information determined by the at least one sensor is realistic or not when the piece good is moved. Tolerances can be taken into account here. This makes it possible to determine if the at least one sensor on the gripping element is not working with sufficient accuracy. The control sensor can thus ensure the operational safety of the gripping device.

Optionally, the gripping element is a mechanical gripping element and/or a suction gripping element. A mechanical gripping element can be a pincer-like gripping element that is designed to handle piece goods by bringing them into engagement. The suction gripping element can be designed to suck in and hold a piece good by means of negative pressure in order to handle it. The suction gripper element can have one or more grippers in the form of suction cups that can be subjected to negative pressure. It is also conceivable that a combination of mechanical gripper element and suction gripper element is provided. Furthermore, an interchangeable element that uses the mechanical gripper element and the suction gripper element depending on the piece good information could also be used.

Optionally, the gripping element comprises a plurality of grippers. In other words, a large number of individual grippers can be provided, which together form the gripping element. This means that even heavy piece goods can be handled.

Optionally, at least one sensor is assigned to each gripper so that a force can be determined between the piece good and the respective gripper height. This makes it possible to determine with spatial resolution at which position of the gripping element which force is acting.

Optionally, the at least one sensor is provided directly on the respective gripper. A measurement directly in the vacuum gripper provides the effect that different suction forces can also be compensated for by an inhomogeneous surface of the piece goods (for example, a square 2×2 gripper where one gripper fails becomes an asymmetrical 3-fold gripper with a heavier load on a single gripper). This means that it is still possible to reliably determine which is the optimum orientation of the piece good for handling it.

Optionally, the grippers are arranged as an array. In other words, the grippers can be arranged on the gripping element in a specific shape so that a spatially resolved determination of the forces between the piece good and the gripping element is possible.

Optionally, the control unit is designed to determine individual force information for each gripper, which is indicative of a force acting between the piece good and the respective gripper. This makes it possible to control each gripper individually. For example, a gripper that does not have satisfactory contact with the piece good cannot be actuated any further, as this requires energy and does not provide any advantages when handling the piece good.

Optionally, the control unit is designed to activate or deactivate one or more grippers based on the force information. If an array of grippers is provided, for example, only some of the grippers can be activated at the start of handling the piece good. If the force information then indicates that the force is not sufficient to handle the piece good satisfactorily, further grippers in the gripper array can be activated. Similarly, if it is determined that the piece good can also be handled with fewer grippers, some of the grippers can be deactivated to save energy. This allows the piece goods to be handled efficiently.

Optionally, the control unit can be designed to deactivate at least one gripper, in particular temporarily, in order to determine the force information. For example, one gripper can be deactivated when handling the piece good in order to determine the effect on the other grippers. In other words, a test mechanism can be used that can provide a remedy if the force information is not determined accurately. For example, it may be the case that the center of gravity of the piece good cannot be determined precisely (e.g. due to a specific system). In such a case, one or more grippers can be temporarily deactivated in order to overcome the overdetermination of the system. During the deactivation of one or more grippers, the force information of the other grippers can be determined and thus the center of gravity of the piece good can be determined.

According to a further aspect of the present disclosure, a handling system for handling piece goods is provided. The handling system may comprise a gripping device according to one of the above embodiments. Further, the handling system may comprise a conveying device designed to convey at least one mail item to the at least one gripping device. The conveying device may, for example, be a conveyor belt. The conveyor belt can be a starting position from which the at least one gripping device picks up piece goods. Furthermore, the handling system can comprise one or more end positions which serve as a target position at which the piece goods are to be conveyed by the at least one gripping device.

According to a further aspect of the present disclosure, a method for handling piece goods is provided. The method may comprise handling a piece good with a gripping device comprising at least one gripping element. Further, the method may comprise determining force information indicative of a force acting between the gripping element and the piece good. Furthermore, the method may comprise adapting the handling of the piece good based on the force information.

Adjusting the handling of the piece good may involve moving and/or orienting the piece good held by the gripping element.

According to a further aspect of the present disclosure, a use of the gripping device according to one of the above embodiments in the handling of piece goods is provided.

Individual features or embodiments can be combined with other features or other embodiments to form new embodiments. Advantages and embodiments of the features and embodiments also apply analogously to the new embodiments. Embodiments and advantages explained in connection with the device also apply analogously to the method and vice versa.

### BRIEF DESCRIPTION OF THE DRAWINGS

In the following, embodiments are described in detail with reference to the attached figures.

FIG. 1 is a schematic view of a gripping device according to an embodiment of the present disclosure;

FIG. 2 is a top view of a gripping element according to an embodiment of the present disclosure.

FIG. 3 is a schematic flow chart of a method according to one embodiment of the present disclosure.

### DETAILED DESCRIPTION OF THE PREFERRED EMBODIMENTS

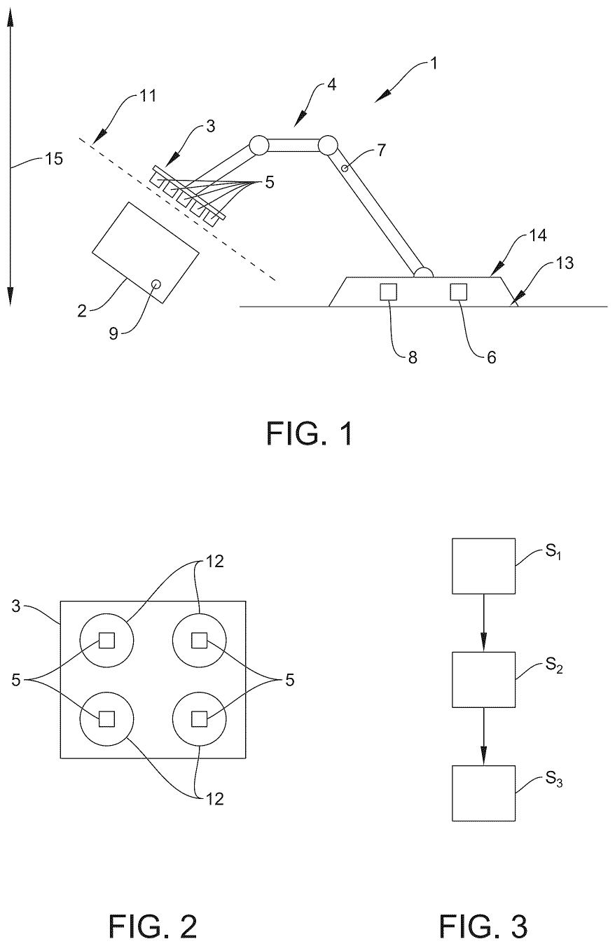

FIG. 1 is a schematic view of a gripping device 1 according to an embodiment of the present disclosure. In the present embodiment, the gripping device 1 is a robot arm-like device with a gripping element 3 and an actuator 4. In the present embodiment, the actuator 4 has at least one joint and a drive unit (not shown). In the present embodiment, the gripping element 3 has a plurality of sensors 5 in the form of vacuum suction cups. The gripping device is firmly mounted on the underground 13 by means of a base 14. The gripping device 1 can move freely in space so that the gripping element can move in all six degrees of freedom. The gripping element 3 can suck in and hold a piece good 2. A contact surface between the piece good 2 and the gripping element 3 is defined by a gripping level 11. The gripping element 3 has a large number of sensors 5, each of which is arranged in a vacuum suction cup 12. Furthermore, the gripping device 1 has an additional control sensor 7. The control sensor 7 is an additional sensor for redundant testing of the other sensors 5. Each sensor 1 can determine the respective force on the respective gripper 12. This information (also referred to as force information) is fed to the control unit 6 of the gripping device 1. The control unit 6 can then control the actuator 4 in order to move and/or align the piece good in space by means of the gripping element 3. The piece good 2 can have a center of gravity 9 that lies outside the geometric center of gravity. In other words, the dimensions of the piece good 2 cannot provide any indication of the center of gravity of the piece good 2. The control unit can use the individual force information from each sensor to determine the actual center of gravity 9 of the piece good 2. The control unit 6 can then control the actuator 4 so that the gripping element, which has gripped the piece good 2, is positioned in 3-dimensional space so that the center of gravity 9 of the piece good 2 is located directly below the direction of gravity 15. This allows a lever arm to be shortened.

FIG. 2 shows a schematic, enlarged view of a gripping element 3. FIG. 2 shows that the gripping element 3 has a large number of grippers 12, each with an associated sensor 5. The gripping element 3 therefore has an array-like arrangement of grippers 12. The control unit can know the exact arrangement of the grippers 12 in the gripping element 3 as well as their dimensions. This allows the force information, which is determined by the sensors 5, to be spatially assigned.

FIG. 3 is a schematic flow chart of a method according to one embodiment of the present disclosure. In step S1, a piece good 2 is handled by the gripping device 1 with at least one gripping element 3. In other words, in step S1, the gripping element 3 contacts the piece good 2. After contact between the gripping element 3 and the piece good 2, in step S2, force information is determined which is indicative of a force acting between the piece good 2 and the gripping element 3. In other words, the force information is determined as soon as the handling of the piece good 2 has begun. In step S3, the handling of the piece good 2 is then adjusted based on the force information.

### LIST OF REFERENCE SIGNS

1 Gripping device
2 Piece good
3 Gripping element
4 Actuator
5 Sensor
6 Control unit
7 Control sensor
8 Storage unit
9 Center of gravity
10 Handling system
11 Gripping level
12 Gripper
13 Underground
14 Base
15 Direction of gravity

The invention claimed is:

1. A gripping device for handling piece goods for use in a sorting process, comprising:
a gripping element which is configured to handle a piece good;
an actuator which is configured to move and/or align the gripping element;
at least one sensor configured to determine the force acting on the gripping element by the piece good and to output it as force information; and
a control unit configured to control the actuator in such a way that the piece good is aligned and/or moved in space based on the force information.

2. The gripping device according to claim 1, wherein the control unit is configured to control the actuator in such a way that the force acting on the gripping element is minimized.

3. The gripping device according to claim 1, wherein the control unit is configured to control the actuator based on the force information in such a way that the piece good is balanced on the gripping element.

4. The gripping device according to claim 1, wherein the control unit is configured to determine and/or obtain a center of gravity of the piece good based on the force information and to control the actuator based on the center of gravity of the piece good.

5. The gripping device according to claim 1, wherein the control unit is configured to control the actuator based on the force information in such a way that a center of gravity of the piece good lies on a line with the gripping element, wherein the line is parallel to the direction of gravity.

6. The gripping device according to claim 1, wherein the control unit is configured to control the actuator based on an inertial force of the piece good.

7. The gripping device according to claim 1, wherein the control unit is configured to control the actuator in such a way that, by iterative displacement of the piece good, the position is determined at which a force acting on the gripping element through the piece good is minimal.

8. The gripping device according to claim 1, wherein the control unit is configured to control a handling speed of the actuator based on the force information.

9. The gripping device according to claim 1, wherein the control unit is configured to determine an optimum gripping point of a piece good, so that when the piece good is handled with the gripping device, the force acting on the gripping element is minimized.

10. The gripping device according to claim 1, wherein the control unit is configured to determine a mass of a piece good based on the force information.

11. The gripping device according to claim 1, wherein the control unit is configured to control the actuator in such a way that, by iterative displacement and/or reorientation of the piece good, the position is determined at which a force acting on the gripping element by the piece good is minimized.

12. The gripping device according to claim 1, wherein the control unit is configured to determine an optimum gripping point of a piece good, so that when the piece good is handled with the gripping device, the force acting on the gripping element is minimized.

13. The gripping device according to claim 1, wherein the control unit is configured to store the optimum gripping point in a storage unit.

14. The gripping device according to claim 1, wherein the control unit is configured to load the optimum gripping point from the storage unit.

15. The gripping device according to claim 1, wherein the at least one sensor is provided directly on the gripping element.

16. The gripping device according to claim 1, further comprising:
a control sensor for monitoring the function of the at least one sensor.

17. The gripping device according to claim 1, wherein the gripping element comprises a plurality of grippers.

18. The gripping device according to claim 1, wherein the control unit is configured to determine, for each gripper individually, force information which is indicative of a force acting between the piece good and the respective gripper.

19. The gripping device according to claim 1, wherein the at least one sensor is provided directly on the respective gripper.

20. The gripping device according to claim 1, wherein the control unit is configured to activate or deactivate one or more grippers based on the force information.

21. The gripping device according to claim 1, wherein the control unit is configured to deactivate at least one gripper in order to determine the force information.

22. A handling system for handling piece goods, comprising:
at least one gripping device according to claim 1; and
a conveying device which is configured to convey at least one mail item to the at least one gripping device.

23. A method of handling piece goods, comprising:
handling of a piece good with a gripping device with at least one gripping element;
determining force information which is indicative of a force acting between the piece good and the gripping element; and
adjusting the handling of the piece good based on the force information.
